(19) United States
(12) Patent Application Publication
(10) Pub. No.: US 2017/0008994 A1
(43) Pub. Date: Jan. 12, 2017

(54) Reaction Hybrid Benzoxazine Resins and Uses Thereof

(71) Applicant: HUNTSMAN ADVANCED MATERIALS AMERICAS LLC, The Woodlands, TX (US)

(72) Inventors: Dong Wang, The Woodlands, TX (US); Derek S Kincaid, Spring, TX (US); Ronald C Smith, Jr., Conroe, TX (US); Bradley Rechichar, The Woodlands, TX (US)

(21) Appl. No.: 15/119,514

(22) PCT Filed: Feb. 10, 2015
(86) PCT No.: PCT/US15/15192

§ 371 Date: Aug. 17, 2016

Related U.S. Application Data
(60) Provisional application No. 61/944,598, filed on Feb. 26, 2014.

(51) Int. Cl. C08G 14/06; C08J 5/24; C09D 161/34; C08L 61/34; C09J 161/34

(52) U.S. Cl. CPC C08G 14/06; C08L 61/34; C09J 161/34; C09D 161/34; C08J 5/24; C08J 2361/34

(57) ABSTRACT

The present disclosure provides a hybrid benzoxazine resin and a method for producing such a resin by reacting an aldehyde compound and an organic primary monoamine with a multifunctional phenol monomer and a monofunctional phenol monomer in the presence or absence of a solvent. The hybrid benzoxazine resin may be easily recovered and provides a resin that is substantially monofunctional phenol-free and therefore useful in a variety of applications and products, such as in aerospace and transportation interior applications and products.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF INVENTION

This disclosure relates to: hybrid benzoxazines resins; methods for producing such hybrid benzoxazine resins from a combination of monofunctional and multifunctional phenol monomers, an aldehyde compound and a primary amine compound; and their uses in various applications.

### BACKGROUND OF THE INVENTION

Developed and commercialized more than one hundred years ago, phenolic formaldehyde or phenolic resins are still widely used today as binders or matrix resins in a variety of aerospace and industrial fibre reinforced plastic (FRP) composite areas. These resins exhibit excellent dimensional stability and good chemical and corrosion resistance. Resole-based phenolic resins have especially been well established in aerospace and other transportation interior applications mainly due to their excellent flame, smoke, and toxicity (FST) performance coupled with favourable economics. However, there are several issues related to traditional phenolic resins and their composite manufacturing processes. As the curing is based on a condensation reaction mechanism, a significant amount of volatiles are released during processing which leads to processing challenges and long manufacturing cycle times. This also generates increasing concerns with regards to environmental, health and safety (EHS) issues. Due to the voids created by volatiles release in both macro- and micro-scale, the qualities of final laminate parts are usually difficult to control, and they typically have very low mechanical strength and poor impact resistance when compared to epoxy or other thermoset resin systems. The manufacturing processes are also mainly limited to a solvent based pre-pregging technique, since the resin is usually a high melting point solid and has limited storage stability.

With more stringent EHS regulations in place, and the need to improve final composite to mechanical performance within the industry, there have been strong interests and significant efforts recently on modifying or developing new fire-retardant resins to replace current phenolic resins for use in transportation interior applications. Furthermore, in order to improve fabrication efficiency and reduce manufacturing cost and cycle time, more liquid molding manufacturing processes are being adopted within the industry. It is desirable, but challenging, to develop new fire-retardant resin systems for transportation interior applications that can not only be used in solvent pre-pregging processes, but can also be easily paired with liquid molding processes such as resin transfer molding (RTM), vacuum assisted RTM (VARTM), and resin film infusion (RFI). Epoxy-based systems exhibit excellent mechanical strength and processing characteristics but have inherently poor FST properties without significant formulation work or chemical modification, which on the other hand would usually lead to some sacrifice in mechanical and processing properties. Cyanate ester resins have excellent FST properties, high thermal and physical performances, and good processability, but high material costs limit the extent of their application in transportation interior applications.

Benzoxazine resins are a new type of thermoset resin that has drawn immense interest in recent decades. This new type of thermoset resin shows a combination of superior properties, including high modulus, very low moisture absorption, good chemical resistance, low curing shrinkage, and long shelf life. With good FST performance and generally low production cost, they have recently been used as a replacement for traditional phenolic resins. For example, benzoxazines based on monofunctional phenols, such as phenol or cresol, have been used in place of phenolic resins due to their excellent FST and mechanical properties and good processability with their comparatively low viscosity. However, because side reactions and incomplete reactions occur during their preparation, excessive residual monofunctional phenol is typically seen in the final resin product. This residual monofunctional phenol is volatile and must be removed causing environmental concerns and extra processing steps.

Notwithstanding the state of the technology, it would be desirable to provide a benzoxazine resin substantially free of monofunctional phenol that exhibits a well-balance of properties, such as, low viscosity, high reactivity, and good mechanical modulus, strength and FST properties.

### SUMMARY OF THE INVENTION

The present disclosure provides a hybrid benzoxazine resin substantially free of monofunctional phenol. In one embodiment, the hybrid benzoxazine resin is the product of mixing and reacting an aldehyde and an organic primary monoamine with a monofunctional phenol monomer and a multifunctional phenol monomer in the presence or absence of a solvent.

The hybrid benzoxazine resin thus produced may be used alone or in combination with other components in a thermosetting resin composition which is useful in a variety of applications and products such as in coating, adhering, laminating and impregnating applications and products.

### BRIEF DESCRIPTION OF FIGURES

For a detailed understanding and better appreciation of the present invention, reference should be made to the following detailed description of the invention, taken in conjunction with the accompanying FIGURE.

FIG. 1 is a graph describing the residual monofunctional phenol levels in various benzoxazine resins and blend of resins.

### DETAILED DESCRIPTION OF THE INVENTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical object of the article. By way of example, “a multifunctional phenol monomer” means one multifunctional phenol monomer or more than one multifunctional phenol monomer. The phrases “in one embodiment,” “according to one embodiment,” and the like generally mean the particular feature, structure, or characteristic following the phrase is included in at least one embodiment of the present invention, and may be included in more than one embodiment of the present disclosure. Importantly, such phases do not necessarily refer to the same embodiment. If the specification states a component or feature “may”, “can”, “could”, or “might” be included or have a characteristic, that particular component or feature is not required to be included or have the characteristic.

As used herein, a hybrid benzoxazine resin that is “substantially monofunctional phenol-free” is meant to say that minimal, preferably no monofunctional phenol is present in the hybrid benzoxazine resin except for trace amounts. Preferably any such amounts are less than 5% by weight, more preferably less than 3.0% by weight, even more preferably less than 1.0% by weight and especially less than 0.75% by weight, or even more especially less than 0.6% by weight, relative to the total weight of the hybrid benzoxazine resin.

The present disclosure provides a hybrid benzoxazine resin that is substantially monofunctional phenol-free. The hybrid benzoxazine resin is a copolymer and may be manufactured or obtained by combining an aldehyde compound and an organic primary monoamine with a monofunctional phenol monomer and a multifunctional phenol monomer in the presence or absence of solvent to form a reactant mixture and allowing the reactant mixture to react under conditions sufficient or favourable to form the hybrid benzoxazine resin. It has been surprisingly found that the hybrid benzoxazine resin of the present disclosure produced from such a reaction mixture is substantially monofunctional phenol-free as compared to state of the art benzoxazine resins or blends of resins. In addition, the hybrid benzoxazine resin of the present disclosure exhibits a well-balance of desired properties including: low viscosity, high reactivity, high modulus and mechanical strength, and good FST performance making it particular useful by itself or in combination with other components in thermosetting compositions useful in various applications and products, such as, aerospace, transportation or industrial composite applications and products.

The aldehyde compound used in the reaction to manufacture the hybrid benzoxazine resin may be any aldehyde, including, but not limited to, formaldehyde, acetaldehyde, propionaldehyde or butylaldehyde, or an aldehyde derivative such as, but not limited to, paraformaldehyde and polyoxymethylene, with formaldehyde and paraformaldehyde being preferred. The aldehyde compound may also be a mixture of aldehydes and/or aldehyde derivatives.

In one particular embodiment, the aldehyde compound is a compound having the formula QCHO, where Q is hydrogen, an aliphatic group having from 1 to 6 carbon atoms, or a cyclic group having 1 to 12 carbon atoms, with 1 to 6 carbon atoms being preferred. Preferably Q is hydrogen.

The organic primary monoamine compound used in the reaction is a compound represented by the general formula R—NH₃ where R is a linear or branched alkyl radical having 2 to 8 carbon atoms, a cycloalkyl radical, an arylene radical, an aralkylene radical, a linear or branched radical having 2 to 8 carbon atoms and containing one or more heteroatoms, a cycloalkyl radical containing one or more heteroatoms, an arylene radical containing one or more heteroatoms, or an aralkylene radical having one or more heteroatoms, these radicals being optionally substituted by C₁ to C₄ alkyl radicals or alkoxy radicals. R may also be a radical of the type aryl-CO—NH—.

Examples of organic primary monoamine compounds include, but are not limited to, ammonium, methylamine, ethylamine, propylamine, butylamine, isopropylamine, hexylamine, octadecylamine, cyclohexylamine, 1-aminoanthracene, 4-aminobenzaldehyde, 4-aminobenzophenone, aminobiphenyl, 2-amino-5-bromo pyridine, D-3-amino-ε-caprolactam, 2-amino-2,6-dimethylpiperidine, 3-amino-9-ethylcarbozole, 4-(2-aminoethyl)morpholine, 2-aminofluorene, 1-aminohomopiperidine, 9-aminophenanthrene, 1-aminopyrene, 4-bromoaniline, aniline, toluidene, xylidene, naphthylamine and mixtures thereof.

According to one embodiment, the monofunctional phenol monomer is a compound selected from phenol, o-cresol, p-cresol, m-cresol, p-tert-butylphenol, p-octylphenol, p-cumylphenol, dodecylphenol, o-phenylphenol, p-phenylphenol, 1-naphthol, 2-naphthol, m-methoxyphenol, p-methoxyphenol, m-ethoxyphenol, dimethylphenol, 3,5-dimethylphenol, xylenol, 2-bromo-4-methylphenol, 2-allylphenol and a mixture thereof.

In another embodiment, the monofunctional phenol monomer is a compound selected from phenol, o-cresol, p-cresol, m-cresol, and a mixture thereof. In still another embodiment, the monofunctional phenol monomer is phenol.

In a further embodiment, the multifunctional phenol monomer may be a compound having a formula (1), (2) or (3):

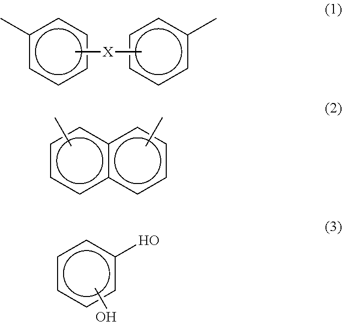

where X is a direct bond, an aliphatic group, an alicyclic group or an aromatic group which may contain a hetero element or functional group. In formula (2), X may be bonded to an ortho position, meta position or para position of each hydroxyl group.

In one embodiment, X has one of the following structures

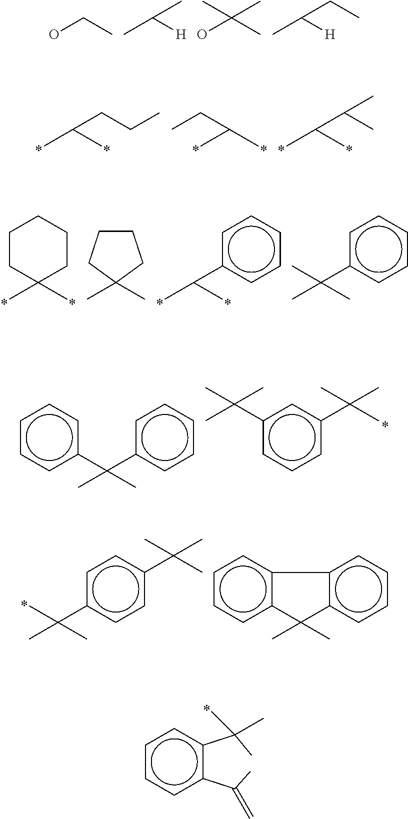

where * represents a binding site to a benzene ring in formula (2).

The multifunctional phenol monomer may also be a trisphenol compound, for example, 1,3,5-trihydroxy benzene, a phenol-novolac resin, a styrene-phenol copolymer, a xylene-modified phenol resin, a melamine-modified phenol resin, a xylene-modified phenol resin or a biphenylene-modified phenol resin.

In one particular embodiment, the multifunctional phenol monomer is a compound selected from phenolphthalein, biphenol, 4-4′-methylene-di-phenol, 4-4′-dihydroxybenzophenone, bisphenol-A, bisphenol-S, bisphenol-F, 1,8-dihydroxyanthraquinone, 1,6-dihydroxnaphthalene, 2,2′-dihydroxyazobenzene, resorcinol, fluorene bisphenol, 1,3,5-trihydroxy benzene and a mixture thereof.

The amounts of monofunctional phenol monomer and multifunctional monomer used will vary depending on the particular phenol monomers used. According to one embodiment, the weight ratio of multifunctional phenol monomer to monofunctional phenol monomer ranges from about 90:10 to about 10:90. In another embodiment, the weight ratio of multifunctional phenol monomer to monofunctional phenol monomer ranges from about 80:20 to about 20:80. In still another embodiment, the weight ratio of multifunctional phenol monomer to monofunctional phenol monomer ranges from about 70:30 to about 30:70. In still yet another embodiment, the weight ratio of multifunctional phenol monomer to monofunctional phenol monomer ranges from about 60:40 to about 40:60. According to other embodiments, the amount of multifunctional phenol monomer will be at least 50% by weight, preferably at least 60% by weight, more preferably at least 70% by weight, still even more preferably at least 80% by weight, and especially at least 90% by weight, based on the total weight of the monofunctional phenol monomer and multifunctional phenol monomer. While in other embodiments, the amount of monofunctional phenol monomer will be at least 50% by weight, preferably at least 60% by weight, more preferably at least 70% by weight, still even more preferably at least 80% by weight, and especially at least 90% by weight, based on the total weight of the monofunctional phenol monomer and multifunctional phenol monomer.

The reaction between the aldehyde compound, organic primary monoamine compound and phenol monomers may occur in the presence or absence of a solvent. Thus, in one embodiment, the reaction occurs in the absence of solvent. In another embodiment, the reaction occurs on the presence of a solvent with the proviso that the solvent is not a polar aprotic solvent. Solvents which may be used in the present disclosure include: aromatics such as toluene, ethylbenzene, butylbenzene, xylene, cumene, mesitylene, chlorobenzene, dichlorobenzene, o-chlorotoluene, n-chlorotoluene and p-chlorotoluene; alcohols, such as methanol, ethanol, propanol, isopropanol, and t-butyl alcohol; ethers, such as ethyl ether, dipropyl ether and THF; ketones, such as acetone and MEK; and hydrocarbons or halogenated hydrocarbons such as octanes, methylcyclohexane, 1,2-dichloroethane, 1,2-dichloropropane, carbon tetrachloride, 1,1,1-trichloroethane, 1,1,2-trichloroethane, 1,1,1,2-tetrachloroethane, 1,1,2,2-tetrachloroethane, trichloroethylene, and tetrachloroethylene. The solvent may also be a mixture of the solvents above.

The stoichiometry of reactants is well within the skill of those conversant in the art, and the required relative amounts may be readily selected depending on the functionality of the reactants. However, in one particular embodiment, about 0.5 mol to about 1.2 mol of the organic primary monoamine compound per mol of (multifunctional phenol monomer mol+monofunctional phenol monomer mol) is used. In another embodiment, about 0.75 mol to 1.1 mol of the organic primary monoamine compound per mol of (multifunctional phenol monomer mol+monofunctional phenol monomer mol) is used. In yet another embodiment, about 1.7 mol to about 2.3 mol of the aldehyde compound per mol of the organic primary monoamine compound is used. In still another embodiment, about 1.8 mol to 2.2 mol of the aldehyde compound per mol of the organic primary amine compound is used. In another embodiment, the molar ratio of (multifunctional phenol monomer mol+monofunctional phenol monomer mol) to aldehyde compound may be from about 1:3 to 1:10, preferably from about 1:4: to 1:7, and more preferably from about 1:4.5 to 1:5 and the molar ratio of (multifunctional phenol monomer mol+monofunctional phenol monomer mol) to organic primary monoamine compound may be from about 1:1 to 1:3, preferably from about 1:1.4 to 1:2.5, and more preferably from about 1:2.1 to 1:2.2.

In another embodiment, the present disclosure provides a method for producing the hybrid benzoxazine resin that is substantially monofunctional phenol-free. The method includes combining the aldehyde compound, organic primary monoamine, multifunctional phenol monomer, monofunctional phenol monomer and optional solvent to form a reactant mixture and heating the reactant mixture for a time sufficient to allow the reactants to react and form the hybrid benzoxazine resin. In some embodiments, the aldehyde compound, organic primary monoamine and phenolic monomers may be combined in water and optionally with solvent, to form the reactant mixture. When a solvent is used, it may constitute from about 0.5% to about 10% by weight of the total weight of the reactant mixture.

The reactants may be mixed together in any appropriate order. Because the reaction is exothermic, attention must be paid to an abrupt increase in temperature of the reactant mixture. In some embodiments, the phenol monomer mixture is dissolved in the water and/or solvent if present first and the aldehyde compound is added to this mixture. The resulting mixture is stirred well, and then the organic primary monoamine, or a solution obtained by dissolving the organic primary monoamine into a solvent, may be added gradually to the reactant mixture in several small increments or continuously. The rate of addition is a rate such that bumping does not occur.

In one embodiment, it has been surprisingly found that with the appropriate phenol monomer addition order and timing, the reaction kinetics may be controlled such that the hybrid benzoxazine resin produced exhibits unexpectedly low residual monofunctional phenol monomer content. According to one particular embodiment, the monofunctional phenol monomer and multifunctional phenol monomer are combined and added together at the same time to the reactant mixture and allowed to react. In another embodiment, the monofunctional phenol monomer is added first to the reactant mixture and allowed to react for sufficient period of time prior to the addition of the multifunctional phenol monomer to the reactant mixture. In still another embodiment, the monofunctional phenol monomer and a portion of the multifunctional phenol monomer are combined and added to the reactant mixture at the same time and allowed to react for a sufficient period of time before the remaining portion of the multifunctional phenol monomer is added to the reactant mixture and allowed to react.

The reaction temperature employed to generate the hybrid benzoxazine resin will vary depending on the nature of the particular components which make up the reaction mixture. Generally, the reaction temperature may range from ambient temperature to about 150° C. In other embodiments, the reaction temperature may range from about 50° C. to about 100° C. In still other embodiments, the reaction temperature may range from about 60° C. to about 90° C.

The reaction is generally done at atmospheric pressure. However, in some embodiments, the reaction may be done under an elevated pressure, such as up to about 100 psi.

A sufficient period of time to form the hybrid resin will vary depending on the nature of the particular components which make up the reaction mixture. Those of ordinary skill are capable of monitoring the reaction progress in order to determine when the reaction has proceeded sufficiently to produce the hybrid benzoxazine resin. In some embodiments, the period of time of reaction may range from about 10 minutes to about 45 minutes, while in other embodiments the period of time of reaction time may range from about 10 minutes to 10 hours. In still other embodiments, the period of time of reaction may range from about 30 minutes to about 4 hours, while in other embodiments it may range from about 1 hour to about 3 hours.

While no catalyst is required for use in the reaction leading to the formation of the hybrid benzoxazine resin, in one embodiment, an acid catalyst or basic catalyst may be employed and added to the reactant mixture. Examples of suitable acid catalysts include, but are not limited to, those selected from HCl, trifluoroacetic acid, methane sulfonic acid, p-toluenesulfonic acid, trifluoromethanesulfonic acid, benzoic acid and mixtures thereof. Examples of basic catalysts include, but are not limited to, those selected from NaOH, Na₂CO₃, triethylamine, triethanolamine and mixtures thereof. The acid catalyst or basic catalyst may be added during or after formation of the reaction mixture.

After a period of time sufficient to form the hybrid benzoxazine resin has elapsed, the reactant mixture may be poured onto cold water to precipitate out the hybrid benzoxazine resin. The solid may then be washed with water and dried to produce the final hybrid resin product. In other embodiments, the hybrid benzoxazine resin may be separated from the reaction mixture by applying heat to the mixture to evaporate water and optional solvent under vacuum. The liquid resin product may then be washed with water and/or aqueous base to remove any unreacted phenol monomer. The final hybrid benzoxazine resin may then be recovered by methods known to those skilled in the art, for example by, precipitation using a poor solvent, solidification by concentration (evaporating under reduced pressure), and spray-drying.

According to another embodiment, there is provided a thermosetting composition comprising the hybrid benzoxazine resin that is substantially monofunctional phenol-free obtained according to the present disclosure.

The hybrid benzoxazine resin of the present disclosure may be used alone to form the thermosetting composition, or combined with one or more optional components, such as an epoxy resin, a polyphenylene ether resin, a polyimide resin, a silicone resin, a melamine resin, urea resin, cyanate ester resin, a polyphenol or phenol resin, an allyl resin, a polyester resin, a bismaleimide resin, an alkyd resin, a furan resin, a polyurethane resin, an aniline resin, a curing agent, a flame retardant, a filler, a release agent, an adhesion-imparting agent, a surfactant, a colorant, a coupling agent, and/or a leveling agent to form the thermosetting composition. The thermosetting composition may be used in a variety of applications and products, such as, casting, laminating, impregnating, coating, adhering, sealing, painting, binding, insulating, or in embedding, pressing, injection molding, extruding, sand mold binding, foam and ablative materials.

According to one embodiment, the hybrid benzoxazine resin may be included in the thermosetting composition in an amount in the range of between about 10% to about 99.9% by weight, based on the total weight of the thermosetting composition. In another embodiment, the hybrid benzoxazine resin may be included in the thermosetting composition in an amount in the range of between about 15% to about 90%, based on the total weight of the thermosetting composition, or even between about 25% to about 75% by weight, based on the total weight of the thermosetting composition. In embodiments where less shrinkage during curing and higher modulus are desired in the cured article, the hybrid benzoxazine resin may be included in the thermosetting composition in an amount in the range of between about 10% to about 25% by weight, based on the total weight of the thermosetting composition.

According to one particular embodiment, the thermosetting composition also contains an epoxy resin. The epoxy resin, which increases crosslink density and lowers the viscosity of the composition, may be any compound having an oxirane ring. In general, any oxirane ring-containing compound is suitable for use as the epoxy resin in the present disclosure, such as the epoxy compounds disclosed in U.S. Pat. No. 5,476,748 which is incorporated herein by reference. The epoxy resin may be solid or liquid. In one embodiment, the epoxy resin is selected from a polyglycidyl epoxy compound; a non-glycidyl epoxy compound; an epoxy cresol novolac compound; an epoxy phenol novolac compound and mixtures thereof.

The polyglycidyl epoxy compound may be a polyglycidyl ether, poly(β-methylglycidyl) ether, polyglycidyl ester or poly(β-methylglycidyl) ester. The synthesis and examples of polyglycidyl ethers, poly(β-methylglycidyl) ethers, polyglycidyl esters and poly(β-methylglycidyl) esters are disclosed in U.S. Pat. No. 5,972,563, which is incorporated herein by reference. For example, ethers may be obtained by reacting a compound having at least one free alcoholic hydroxyl group and/or phenolic hydroxyl group with a suitably substituted epichlorohydrin under alkaline conditions or in the presence of an acidic catalyst followed by alkali treatment. The alcohols may be, for example, acyclic alcohols, such as ethylene glycol, diethylene glycol and higher poly(oxyethylene) glycols, propane-1,2-diol, or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol and sorbitol. Suitable glycidyl ethers may also be obtained, however, from cycloaliphatic alcohols, such as 1,3- or 1,4-dihydroxycyclohexane, bis(4-hydroxycyclo-hexyl)methane, 2,2-bis(4-hydroxycyclohexyl)propane or 1,1-bis(hydroxymethyl)cyclohex-3-ene, or they may possess aromatic rings, such as N,N-bis(2-hydroxyethyl)aniline or p,p′-bis(2-hydroxyethylamino)diphenylmethane.

Particularly important representatives of polyglycidyl ethers or poly(β-methylglycidyl)ethers are based on monocyclic phenols, for example, on resorcinol or hydroquinone, on polycyclic phenols, for example, on bis(4-hydroxyphenyl)methane (Bisphenol F), 2,2-bis(4-hydroxyphenyl)propane (Bisphenol A), bis(4-hydroxyphenyl)sulfone (Bisphenol S), alkoxylated Bisphenol A, F or S, triol extended Bisphenol A, F or S, brominated Bisphenol A, F or S, hydrogenated Bisphenol A, F or S, glycidyl ethers of phenols and phenols with pendant groups or chains, on condensation products, obtained under acidic conditions, of phenols or cresols with formaldehyde, such as phenol novolacs and cresol novolacs, or on siloxane diglycidyls.

Polyglycidyl esters and poly(P-methylglycidyl)esters may be produced by reacting epichlorohydrin or glycerol dichlorohydrin or β-methylepichlorohydrin with a polycarboxylic acid compound. The reaction is expediently carried out in the presence of bases. The polycarboxylic acid compounds may be, for example, glutaric acid, adipic acid, pimelic acid, suberic acid, azelaic acid, sebacic acid or dimerized or trimerized linoleic acid. Likewise, however, it is also possible to employ cycloaliphatic polycarboxylic acids, for example tetrahydrophthalic acid, 4-methyltetrahydrophthalic acid, hexahydrophthalic acid or 4-methylhexahydrophthalic acid. It is also possible to use aromatic polycarboxylic acids such as, for example, phthalic acid, isophthalic acid, trimellitic acid or pyromellitic acid, or else carboxyl-terminated adducts, for example of trimellitic acid and polyols, for example glycerol or 2,2-bis(4-hydroxycyclohexyl)propane, may be used.

In another embodiment, the epoxy resin is a non-glycidyl epoxy compound. Non-glycidyl epoxy compounds may be linear, branched, or cyclic in structure. For example, there may be included one or more epoxide compounds in which the epoxide groups form part of an alicyclic or heterocyclic ring system. Others include an epoxy-containing compound with at least one epoxycyclohexyl group that is bonded directly or indirectly to a group containing at least one silicon atom. Examples are disclosed in U.S. Pat. No. 5,639,413, which is incorporated herein by reference. Still others include epoxides which contain one or more cyclohexene oxide groups and epoxides which contain one or more cyclopentene oxide groups.

Particularly suitable non-glycidyl epoxy compounds include the following difunctional non-glycidyl epoxide compounds in which the epoxide groups form part of an alicyclic or heterocyclic ring system: bis(2,3-epoxycyclopentyl)ether, 1,2-bis(2,3-epoxycyclopentyloxy)ethane, 3,4-epoxycyclohexyl-methyl 3,4-epoxycyclohexanecarboxylate, 3,4-epoxy-6-methyl-cyclohexylmethyl 3,4-epoxy-6-methylcyclohexanecarboxylate, di(3,4-epoxycyclohexylmethyl)hexanedioate, di(3,4-epoxy-6-methylcyclohexylmethyl) hexanedioate, ethylenebis(3,4-epoxycyclohexanecarboxylate), ethanediol di(3,4-epoxycyclohexylmethyl.

Highly preferred difunctional non-glycidyl epoxies include cycloaliphatic difunctional non-glycidyl epoxies, such as 3,4-epoxycyclohexyl-methyl 3′,4′-epoxycyclohexanecarboxylate and 2,2′-bis-(3,4-epoxy-cyclohexyl)-propane, with the former being most preferred.

In another embodiment, the epoxy resin is a poly(N-glycidyl) compound or poly(S-glycidyl) compound. Poly(N-glycidyl) compounds are obtainable, for example, by dehydrochlorination of the reaction products of epichlorohydrin with amines containing at least two amine hydrogen atoms. These amines may be, for example, n-butylamine, aniline, toluidine, m-xylylenediamine, bis(4-aminophenyl)methane or bis(4-methylaminophenyl)methane. Other examples of poly(N-glycidyl) compounds include N,N′-diglycidyl derivatives of cycloalkyleneureas, such as ethyleneurea or 1,3-propyleneurea, and N,N′-diglycidyl derivatives of hydantoins, such as of 5,5-dimethylhydantoin. Examples of poly(S-glycidyl) compounds are di-S-glycidyl derivatives derived from dithiols, for example ethane-1,2-dithiol or bis(4-mercaptomethylphenyl)ether.

It is also possible to employ epoxy resins in which the 1,2-epoxide groups are attached to different heteroatoms or functional groups. Examples include the N,N,O-triglycidyl derivative of 4-aminophenol, the glycidyl ether/glycidyl ester of salicylic acid, N-glycidyl-N′-(2-glycidyloxypropyl)-5,5-dimethylhydantoin or 2-glycidyloxy-1,3-bis(5,5-dimethyl-1-glycidylhydantoin-3-yl)propane.

Other epoxide derivatives may also be employed, such as vinyl cyclohexene dioxide, limonene dioxide, limonene monoxide, vinyl cyclohexene monoxide, 3,4-epoxycyclohexlmethyl acrylate, 3,4-epoxy-6-methyl cyclohexylmethyl 9,10-epoxystearate, and 1,2-bis(2,3-epoxy-2-methylpropoxy)ethane.

Additionally, the epoxy resin may be a pre-reacted adduct of an epoxy resin, such as those mentioned above, with known hardeners for epoxy resins.

According to one embodiment, the epoxy resin may be included in the thermosetting composition in an amount in the range of between about 10% to about 70% by weight, based on the total weight of the thermosetting composition. In another embodiment, the epoxy resin may be included in the thermosetting composition in an amount in the range of between about 15% to about 60% by weight, based on the total weight of the thermosetting composition.

In another embodiment, a cyanate ester resin may be included in the thermosetting composition. The cyanate ester resin is generally a compound having a structure according to (L₁-O—C≡N)_{z} where z is an integer from 2 to 5 and L₁ is an aromatic nucleus-containing residue. Examples of such resins include 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl, bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyesulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene and cyanated, bisphenol-terminated polycarbonate or other thermoplastic oligomer. Other cyanate esters include those disclosed in U.S. Pat. Nos. 4,477,629 and 4,528,366, the disclosure of each of which is hereby expressly incorporated herein by reference; the cyanate esters disclosed in U.K. Patent No. 1,305,702, and the cyanate esters disclosed in International Patent Publication No. WO 85/02184, the disclosure of each of which is hereby expressly incorporated herein by reference. Particularly desirable cyanate esters for use herein are available commercially from Huntsman International LLC under the tradename “AROCY” resins or from Lanza Group, Great Britain under the tradename “PRIMASET” [1,1-di(4-cyanatophenylalkanes)].

According to one embodiment, the cyanate ester resin may be included in the thermosetting composition in an amount in the range of between about 5% to about 70% by weight, based on the total weight of the thermosetting composition. In another embodiment, the cyanate ester resin may be included in the thermosetting composition in an amount in the range of between about 10% to about 60% by weight, based on the total weight of the thermosetting composition.

In another embodiment, the thermosetting composition also contains an acid anhydride. The acid anhydride, which imparts increased crosslink density and thermal, mechanical and toughness properties while lowering the polymerization temperature of the composition, may be any anhydride which is derived from a carboxylic acid and possesses at least one anhydride group, i.e. a

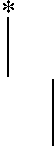

group. The carboxylic acid used in the formation of the anhydride may be saturated, unsaturated, aliphatic, cycloaliphatic, aromatic or heterocyclic. In one embodiment, the acid anhydride is selected from a monoanhydride, a dianhydride, a polyanhydride, an anhydride-functionalized compound, a modified dianhydride adduct and mixtures thereof.

Examples of monohydrides include, but are not limited to, maleic anhydride, phthalic anhydride, succinic anhydride, itaconic anhydride, citraconic anhydride, nadic methyl anhydride, methylhexahydrophthalic anhydride, methyltetrahydrophthalic anhydride, tetrahydrophthalic anhydride, hexahydrophthalic anhydride, trimellitic anhydride, tetrahydrotrimellitic anhydride, hexahydrotrimellitic anhydride, dodecenylsuccinic anhydride and mixtures thereof.

Examples of dianhydrides include, but are not limited to, 1,2,5,6-naphthalene tetracarboxylic dianhydride, 1,4,5,8-naphthalene tetracarboxylic dianhydride, 2,3,6,7-naphthalene tetracarboxylic dianhydride, 2-(3′,4′-dicarboxyphenyl) 5,6-dicarboxybenzimidazole dianhydride, 2-(3′,4′-dicarboxyphenyl) 5,6-dicarboxybenzoxazole dianhydride, 2-(3′,4′dicarboxyphenyl) 5,6-dicarboxybenzothiazole dianhydride, 2,2′,3,3′-benzophenone tetracarboxylic dianhydride, 2,3,3′,4′-benzophenone tetracarboxylic dianhydride, 3,3′,4,4′-benzophenone tetracarboxylic dianhydride (BTDA), 2,2′,3,3′-biphenyl tetracarboxylic dianhydride, 2,3,3′,4′-biphenyl tetracarboxylic dianhydride, 3,3′,4,4′-biphenyl tetracarboxylic dianhydride (BPDA), bicyclo-[2,2,2]-octen-(7)-2,3,5,6-tetracarboxylic-2,3,5,6-dianhydride, thio-diphthalicanhydride, bis (3,4-dicarboxyphenyl) sulfone dianhydride, bis (3,4-dicarboxyphenyl) sulfoxide dianhydride, bis (3,4-dicarboxyphenyl oxadiazole-1,3,4) paraphenylene dianhydride, bis (3,4-dicarboxyphenyl) 2,5-oxadiazole 1,3,4-dianhydride, bis 2,5-(3′,4′-dicarboxydiphenylether) 1,3,4-oxadiazole dianhydride, his (3,4-dicarboxyphenyl) ether dianhydride, 4,4′-oxydiphthalicanhydride (ODPA), bis (3,4-dicarboxyphenyl) thioether dianhydride, bisphenol A dianhydride (BPADA), bisphenol S dianhydride, 2,2-bis (3,4-dicarboxyphenyl) hexafluoropropane dianhydride, hydroquinone bisether dianhydride, his (3,4-dicarboxyphenyl) methane dianhydride, cyclopentadienyl tetracarboxylic acid dianhydride, cyclopentane tetracarboxylic dianhydride, ethylene tetracarboxylic acid dianhydride, perylene 3,4,9,10-tetracarboxylic dianhydride, pyromellitic dianhydride (PMDA), tetrahydrofuran tetracarboxylic dianhydride, resorcinol dianhydride, and trimellitic anhydride (TMA). trimellitic acid ethylene glycol dianhydride (TMEG), 5-(2,5-dioxotetrahydrol)-3-methyl-3-cyclohexene-1,2-dicarboxylicanhydride and mixtures thereof.

If desired, the dianhydride may be blended with a non-reactive diluent to lower the melting point/viscosity of the dianhydride. This dianhydride pre-blend thus contains a dianhydride and a non-reactive diluent, for example, polybutadiene, CTBN, styrene-butadiene, rubber, polysiloxane, polyvinyl ether, polyvinyl amide and mixtures thereof.

Examples of polyanhydrides include, but are not limited to, polysebacic polyanhydride, polyazelaic polyanhydride, polyadipic polyanhydride and mixtures thereof.

Anhydride-functionalized compounds include monomers, oligomers or polymers having anhydride reactive sites on side and/or terminal groups. Particular examples include, but are not limited to, styrene maleic anhydride, poly(methyl vinyl ether-co-maleic anhydride) (such as GANTREZ® AN 119 product available from ISP), polybutadiene grafted with maleic anhydride (such as the “RICON MA” product line from Sartomer and the LITHENE® product line from Synthomer) and polyimide dianhydride prepared by reacting an aromatic diamine with excess dianhydride as described in U.S. Pat. No. 4,410,664 which is incorporated herein by reference.

Modified dianhydride adducts include compounds obtained from the reaction of flexible di- or polyamines with dianhydride at about an equal mole ratio (i.e. at a mole ratio of about 1:1) or with excess dianhydride. Examples of di- or polyamines include, but are not limited to, alkylene diamines such as ethane-1,2-diamine, propane-1,3-diamine, propane-1,2-diamine, 2,2-dimethylpropane-1,3-diamine and hexane-1,6-diamine, aliphatic diamines containing cyclic structures like 4,4′-methylenedicyclohexanamine (DACHM), 4,4′-methylenebis(2-methylcyclohexanamine) and 3-(aminomethyl)-3,5,5-trimethylcyclohexanamine (isophorone diamine (IPDA)); araliphatic diamine like m-xylylene diamine (MXDA); polyether amines, such as Jeffamine® series from Huntsman International LLC or Versalink diamine series from Air Products, amine functional polysiloxanes, such as Fluid NH 15D from Wacker Chemie, or amine functional elastomers, such as Hypro 1300X42 from Emerald Performance Materials.

The modified dianhydride adduct may also be a compound containing an amide linkage and which is obtained from the reaction of a secondary amine and excess dianhydride. Examples of secondary amines include, but are not limited to, functional elastomers, such as Hypro ATBN series from Emerald Performance Materials, functional polysiloxanes, or any other flexible compounds functionalized with secondary amine.

The modified dianhydride adduct may also be a compound containing an ester linkage and which is obtained from the reaction of a hydroxyl-containing compound and excess dianhydride. Examples of hydroxyl-containing compounds include, but are not limited to, hydroxylated polyalkylene ethers, segmented prepolymers containing polyether segments, such as polyether-amides, polyether-urethanes and polyether-ureas, polyalkylene thioether-polyols, hydroxyl-terminated polybutadienes or polyalkylene oxide diols, such as polypropylene oxide diols sold under the tradenames ACCLAIM® by Bayer AG and hydroxyl-terminated polyesters, such as polyethylene and polypropylene glycol esters.

According to one embodiment, the acid anhydride may be included in the thermosetting composition in an amount in the range of between about 5% to about 80% by weight, based on the total weight of the thermosetting composition. In another embodiment, the acid anhydride may be included in the thermosetting composition in an amount in the range of between about 10% to about 60% by weight, based on the total weight of the thermosetting composition.

In another embodiment, the thermosetting composition includes one or more of a novolac or resole resin, maleimide, itaconimide, or nadimide including those described in, for instance, U.S. Pat. No. 6,916,856 and U.S. Patent Publication No. 2004/00077998, the disclosures of each of which being hereby incorporated herein by reference.

In another embodiment, the thermosetting composition may optionally contain one or more additives. Examples of such additives, include, but are not limited to, a toughener, catalyst, flame retardant, solvent reinforcing agent, filler and mixtures thereof. According to some embodiments, it's preferred that the thermosetting composition remain substantially free of solvent so as to avoid the potentially detrimental effects thereof.

Examples of tougheners which may be used include copolymers based on butadiene/acrylonitrile, butadiene/(meth)acrylic acid esters, butadiene/acrylonitrile/styrene graft copolymers (“ABS”), butadiene/methyl methacrylate/styrene graft copolymers (“MBS”), poly(propylene) oxides, amine-terminated butadiene/acrylonitrile copolymers (“ATBN”) and hydroxyl-terminated polyether sulfones, such as PES 5003P, available commercially from Sumitomo Chemical Company or RADEL® from Solvay Advanced Polymers, LLC, core shell rubber and polymers, such as PS 1700, available commercially from Union Carbide Corporation, rubber particles having a core-shell structure in an epoxy resin matrix such as MX-120 resin from Kaneka Corporation, Genioperal M23A resin from Wacker Chemie GmbH. rubber-modified epoxy resin, for instance an epoxy-terminated adduct of an epoxy resin and a diene rubber or a conjugated diene/nitrile rubber.

Examples of catalysts which may be used include thiodiproponic acid, thiodiphenol benzoxazine, sulfonyl benzoxazine, sulfonyl diphenol, amines, polyaminoamides, imidazoles, phosphines and metal complexes of organic sulfur containing acid as described in WO 200915488, which is incorporated herein by reference.

Examples of flame retardants include: phosphorous flame retardants, such as DOPO (9,10-dihydro-9-oxa-phosphaphenanthrene-10-oxide), fyroflex PMP (Akzo; a reactive organophosphorus additive modified with hydroxylgroups at its chain ends and able to react with epoxy resins), CN2645A (Great Lakes; a material which is based on phosphine oxide chemistry and contains phenolic functionality able to react with epoxy resins), and OP 930 (Clariant), brominated polyphenylene oxid and ferrocene.

Examples of solvents include methylethylketone, acetone, N-methyl-2-pyrrolidone, N,N-dimethyl formamide, pentanol, butanol, dioxolane, isopropanol, methoxy propanol, methoxy propanol acetate, dimethylformamide, glycols, glycol acetates and toluene, xylene. The ketones and the glycols are especially preferred.

Examples of filler and reinforcing agents which may be used include silica, silica nanoparticles pre-dispersed in epoxy resins, coal tar, bitumen, textile fibres, glass fibres, asbestos fibres, boron fibres, carbon fibres, mineral silicates, mica, powdered quartz, hydrated aluminum oxide, bentonite, wollastonite, kaolin, aerogel or metal powders, for example aluminium powder or iron powder, and also pigments and dyes, such as carbon black, oxide colors and titanium dioxide, light weight microballoons, such cenospheres, glass microspheres, carbon and polymer microballoons, fire-retarding agents, thixotropic agents, flow control agents, such as silicones, waxes and stearates, which can, in part, also be used as mold release agents, adhesion promoters, antioxidants and light stabilizers, the particle size and distribution of many of which may be controlled to vary the physical properties and performance of the thermosetting composition.

If present, the additive may be included in the thermosetting composition in an amount in the range of between about 0.1% to about 40% by weight, based on the total weight of the thermosetting composition. In further embodiments, the additive may be added to the thermosetting composition in an amount in the range of between about 2% to about 30% by weight, preferably between about 5% to about 15% by weight, based on the total weight of the phenolic-thermosetting composition.

The thermosetting composition according to the present disclosure may be prepared by methods already known, for example, by combining the hybrid benzoxazine resin and optional components and additives with the aid of known mixing units such as kneaders, stirrers, rollers, in mills or in dry mixers.

It has been surprisingly found that the hybrid benzoxazine, resin of the present disclosure, when used in a thermosetting composition, upon curing, produces a cured article having unexpectedly good toughness and flexural strength, even without further toughener modification. Moreover, the cured article also exhibits excellent FST properties meeting FAA regulations.

The thermosetting composition may be cured at elevated temperature and/or pressure conditions to form the cured article. Curing can be carried out in one or two or more stages, the first curing stage being carried out at a lower temperature and the post-curing at a higher temperature(s). In one embodiment, curing may be carried out in one or more stages at a temperature within the range of about 30°-300° C., preferably about 140°-220° C.

As noted above, the thermosetting composition is particular suitable for use as a coating, adhesive, sealant, and matrice for the preparation of reinforced composite material, such as prepregs and towpegs, and can also be used in injection molding or extrusion processes.

Thus, in another embodiment, the present disclosure provides an adhesive, sealant, coating or encapsulating system for electronic or electrical components comprising the thermosetting composition of the present disclosure. Suitable substrates on which the coating, sealant, adhesive or encapsulating system comprising the thermosetting composition may be applied include metal, such as steel, aluminum, titanium, magnesium, brass, stainless steel, galvanized steel; silicates such as glass and quartz; metal oxides; concrete; wood; electronic chip material, such as semiconductor chip material; or polymers, such as polyimide film and polycarbonate. The adhesive, sealant or coating comprising the thermosetting composition may be used in a variety of applications, such as in industrial or electronic applications.

In another embodiment, the present disclosure provides a cured product comprising bundles or layers of fibers infused with the thermosetting composition.

In yet another embodiment, the present disclosure provides a method for producing a prepreg or towpreg including the steps of (a) providing a bundle or layer of fibers; (b) providing a thermosetting composition of the present disclosure; (c) joining the bundle or layer of fibers and thermosetting composition to form a prepreg or towpreg assembly; (d) optionally removing excess thermosetting composition from the prepreg or towpreg assembly, and (e) exposing the prepreg or towpreg assembly to elevated temperature and/or pressure conditions sufficient to infuse the bundle or layer of fibers with the thermosetting composition and form a prepreg or towpreg.

In some embodiments, the bundle or layer of fibers may be constructed from unidirectional fibers, woven fibers, chopped fibers, non-woven fibers or long, discontinuous fibers. The fibers may be selected from glass, such as S glass, S2 glass, E glass, R glass, A glass, AR glass, C glass, D glass, ECR glass, glass filament, staple glass, T glass and zirconium glass, carbon, polyacrylonitrile, acrylic, aramid, boron, polyalkylene, quartz, polybenzimidazole, polyetherketone, polyphenylene sulfide, poly p-phenylene benzobisoxazole, silicon carbide, phenolformaldehyde, phthalate and naphthenoate.

According to another embodiment, there is provided a method for producing a composite article in a resin transfer molding system. The process includes the steps of: a) introducing a fiber preform comprising reinforcement fibers into a mold; b) injecting the thermosetting composition of the present disclosure into the mold, c) allowing the thermosetting composition to impregnate the fiber preform; and d) heating the resin impregnated preform at a temperature of least about 90° C., preferably at least about 90° C. to about 200° C. for a period of time to produce an at least partially cured solid article; and e) optionally subjecting the partially cured solid article to post curing operations to produce the composite article.

In an alternative embodiment, there is provided a method for forming a composite article in a vacuum assisted resin transfer molding system. The process includes the steps of a) introducing a fiber preform comprising reinforcement fibers into a mold; b) injecting the thermosetting composition of the present disclosure into the mold; c) reducing the pressure within the mold; d) maintaining the mold at about the reduced pressure; e) allowing the thermosetting composition to impregnate the fiber preform; and f) heating the resin impregnated preform at a temperature of at least about 90° C., preferably at least about 90° C. to about 200° C. for a period of time to produce an at least partially cured solid article; and e) optionally subjecting the at least partially cured solid article to post curing operations to produce the flame retarded composite article.

The thermosetting composition (and prepregs/towpregs or composite articles prepared therefrom) are particularly useful in aerospace, automotive or other transportation interior applications.

### Examples

### Comparative Example 1

### Phenol Benzoxazine

Into a four-neck flask equipped with a mechanical stirrer, a Dean-Stark trap and a reflux condenser, were charged 101 g of phenol, 70 g of paraformaldehyde and 10 g of water. Toluene was also added as a solvent. The flask containing the reaction solution was then heated to about 80° C. and 100 g of aniline were gradually added to the reaction solution and the reaction was allowed to proceed for several hours. The solvent and water were removed from the reaction mixture by heat and vacuum. The final benzoxazine resin product was a liquid at room temperature with a residual phenol content of 3.2% by weight.

### Comparative Example 2

### Bisphenol-F Benzoxazine

Into a four-neck flask equipped with a mechanical stirrer, a Dean-Stark trap and a reflux condenser, were charged 107 g of bisphenol-F, 70 g of paraformaldehyde and 10 g of water. Toluene was also added as a solvent. The flask containing the reaction solution was then heated to about 80° C. and 100 g of aniline were gradually added to the reaction solution and the reaction was allowed to proceed for several hours. The solvent and water were removed from the reaction mixture by heat and vacuum.

### Example 3

### Hybrid Benzoxazine Resin

Into a four-neck flask equipped with a mechanical stirrer, a Dean-Stark trap and a reflux condenser, were charged 84 g of bisphenol-F, 22 g of phenol, 70 g of paraformaldehyde and 10 g of water. Toluene was also added as a solvent. The flask containing the reaction solution was then heated to about 70°−90° C. and 100 g of aniline were gradually added to the reaction solution and the reaction was allowed to proceed for several hours. The solvent and water were removed from the reaction mixture by heat and vacuum. The hybrid benzoxazine resin product was a sticky solid at room temperature.

### Example 4

### Hybrid Benzoxazine Resin

Into a four-neck flask equipped with a mechanical stirrer, a Dean-Stark trap and a reflux condenser, were charged 64 g of bisphenol-F, 41 g of phenol, 70 g of paraformaldehyde and 10 g of water. Toluene was also added as a solvent. The flask containing the reaction solution was then heated to about 70°−90° C. and 100 g of aniline were gradually added to the reaction solution and the reaction was allowed to proceed for several hours. The solvent and water were removed from the reaction mixture by heat and vacuum. The hybrid benzoxazine resin product was a liquid at room temperature.

The following graph demonstrates the residual monofunctional phenol level for the hybrid benzoxazine resins as compared to the state of the art resin and blend of resins.

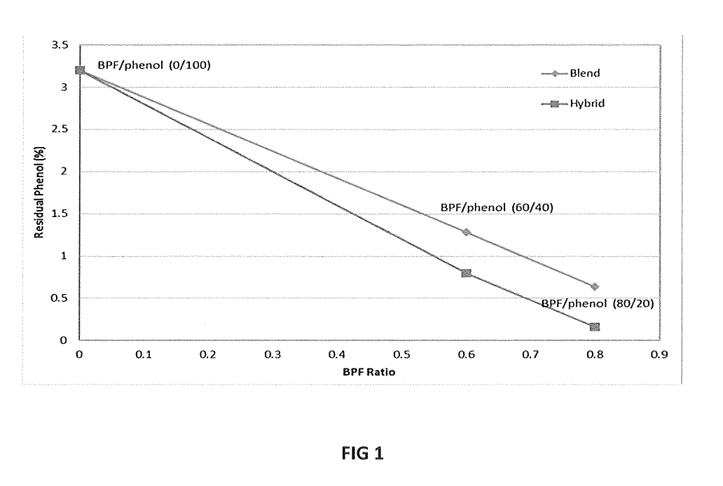

FIG. 1 shows the residual monofunctional phenol level for a phenol-based benzoxazine resin and a blend of phenol-based benzoxazine resin+bisphenol-F-based benzoxazine resin (60/40) is significantly higher than that of the hybrid benzoxazine resins according to the present disclosure.

### Comparative Example 5

### O-Cresol Benzoxazine

Into a four-neck flask equipped with a mechanical stirrer and a reflux condenser were charged 54 g of o-cresol and 83 g of formalin (37%). Toluene was added as a solvent. After 47.4 g of aniline had been gradually added at a temperature of between about 60°-90° C., the reaction was allowed to proceed for an additional 1-2 hrs. The solvent and water were then removed from the reaction mixture by heat and vacuum. The benzoxazine resin obtained was a liquid at room temperature.

### Example 6

### Hybrid Benzoxazine Resin

Into a four-neck flask equipped with a mechanical stirrer and a reflux condenser were charged 65 g of o-cresol and 125 g of formalin. Toluene was also added as a solvent. After 63 g weight of aniline had been gradually added at a temperature of between about 60°-90° C., the reaction was allowed to proceed for an additional 1-2 hrs. After most of the water generated from the reaction had been collected by azeotrope distillation, 7 g of bisphenol-A was then added and the reaction was allowed to proceed for another 40 min. The solvent was then removed by heat and vacuum. The hybrid benzoxazine resin obtained was a liquid at room temperature.

### Example 7

### Hybrid Benzoxazine Resin

Into a four-neck flask equipped with a mechanical stirrer and a reflux condenser were charged 92 g of o-cresol and 70 g of paraformaldehyde. Toluene was added as a solvent. After 95 g of aniline had been gradually added at a temperature of between about 60°-90° C., the reaction was allowed to proceed for an additional 1-2 hrs. After most of the water generated from reaction had been collected by azeotrope distillation, 9 g of resorcinol was added and the reaction was allowed to proceed for another 20 min. The solvent was then removed by heat and vacuum. The hybrid benzoxazine resin obtained was a liquid at room temperature.

The following table describes the residual phenol levels in the resins as well as their curing peak temperature.

TABLE 1
Residual phenol level and reactivity of the benzoxazine and hybrid
benzoxazine resins.

| | Comparative Example 5 | Example 6 | Example 7 |
|---|---|---|---|
| Residual cresol, % | 3.10 | 0.58 | 0.50 |
| Residual di-phenol, % | — | 0.80 | ND |
| DSC curing peak | 261 | 247 | 216 |
| temperature, ° C. | | | |

As depicted above, the residual monofunctional phenol level in the hybrid benzoxazine resins according to the present disclosure is significantly lower than that for a phenol-based benzoxazine. In addition, the resin curing temperatures of the hybrid benzoxazine resins is significantly lower than that for the phenol-based benzoxazine.

### Example 8

The following Table 2 shows the curing performance of the hybrid benzoxazine resin (Example 4) by itself and in a formulation with novolac. As shown in Table 2 below, the hybrid benzoxazine resin exhibits a good T_{g} under 350° F. curing, and 320° F. curing could be achieved by formulating with the novolac.

TABLE 2
The curing properties of the hybrid benzoxazine resin (Example 4).

| | | |
|---|---|---|
| Example 4 hybrid | 100 g | 100 g |
| benzoxazine resin | | |
| Novolac SD-1702 | 0 g | 20 g |
| DSC onset/peak | 215/227 | 174/202 |
| temperature, ° C. | | |
| Curing profile | 160° C./1 h + 177° C./90 min | 160° C./1 h |
| T_{g} by DSC, ° C. | 137/142 (re-run) | 127/143 (re-run) |

The mechanical properties of neat hybrid benzoxazine resin are summarized in the following Table 3. As shown in Table 3, the hybrid benzoxazine resin shows very good toughness and flexural strength even without further toughener modification.

TABLE 3
The mechanical properties of the neat hybrid benzoxazine resin.

| | | Hybrid benzoxazine resin |
|---|---|---|
| Properties | Testing Method | Example 4 |
| Curing conditions | 1 h/300° F. + 2 h/350° F. | |
| Flexural strength, Mpa | ISO 178 | 121 |
| Flexural modulus, Gpa | ISO 178 | 5.2 |
| Tensile strength, Mpa | ISO 527 | 60 |
| Tensile modulus, Gpa | ISO 527 | 4.9 |
| K_{1C,} Mpa · m^{0.5} | ISO 13586 | 0.92 |
| G_{1C}, J/m² | ISO 13586 | 200 |

### Example 9

Laminate properties of the hybrid benzoxazine resin (Example 4).

The mechanical properties of a composite laminate from glass 7781 by resin transfer molding (RTM) are summarized in Table 4. As shown in Table 4, the laminate shows excellent mechanical modulus and strength.

TABLE 4
Laminate mechanical properties of the hybrid benzoxazine
resin (Example 4).

| | | Laminate made from hybrid |
|---|---|---|
| Properties | Method | benzoxazine resin Example 4 |
| Fiber volume content | 50% | |
| Curing condition | 1 h/300° F. + 2 h/350° F. | |
| Flexural Modulus, Gpa | ISO 178 | 27 |
| Flexural Strength, MPa | | 663 |
| Tensile Modulus, GPa | ISO 527 | 28 |
| Tensile Strength, MPa | | 457 |
| ILSS, MPa | ISO 14130 | 50 |
| Compression Modulus, GPa | ISO 14126 | 29 |
| Compression Strength, MPa | | 555 |

### Example 10

FST performance of the hybrid benzoxazine hybrid resin (Example 4).

The FST Properties of a 2 ply laminate from glass 7781 are summarized in the following Table 5. As shown in Table 5, the glass laminate has good FST performances and meets the FAA requirements.

TABLE 5
FST properties of the hybrid benzoxazine resin laminate.

| | | Laminate made |
|---|---|---|
| | | from benzoxazine |
| | | hybrid resin |
| | Test Method | Example 4 |
| Flammability - 60 second vertical | FAR 25.853(a) | |
| burn | | |
| Extinguish Time - | | 0.0 |
| Burn Length - | | 3.7 |
| Drip Extinguish Time - | | 0.0 |
| Smoke Density | FAR 25.853(d) | |
| Specific Optical Density - | | 11 |
| Heat release | FAR 25.853(d) | |
| Total Heat Release - | | 18 |
| Peak Heat Release - | | 29 |
| Toxicity | BSS 7239 | |
| HCN - | | 2 |
| CO - | | 19 |
| NOx - | | 3 |
| SO2 - | | 0 |
| HF - | | 1 |
| HCL - | | 0 |

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

1-21. (canceled)

22. A hybrid benzoxazine resin obtained by combining an aldehyde compound and an organic primary monoamine with a monofunctional phenol monomer and a multifunctional phenol monomer to form a reactant mixture in the presence or absence of solvent and allowing the reactant mixture to react under conditions sufficient to form the hybrid benzoxazine resin wherein the hybrid benzoxazine resin is substantially monofunctional phenol-free.

23. The hybrid benzoxazine resin according to claim 22 wherein the monofunctional phenol monomer is a compound selected from phenol, o-cresol, p-cresol, m-cresol, p-tert-butylphenol, p-octylphenol, p-cumylphenol, dodecylphenol, o-phenylphenol, p-phenylphenol, 1-naphthol, 2-naphthol, m-methoxyphenol, p-methoxyphenol, m-ethoxyphenol, dimethylphenol, 3,5-dimethylphenol, xylenol, 2-bromo-4-methylphenol, 2-allylphenol and a mixture thereof.

24. The hybrid benzoxazine resin according to claim 22 wherein the monofunctional phenol monomer is a compound selected from phenol, o-cresol, p-cresol, m-cresol, and a mixture thereof.

25. The hybrid benzoxazine resin according to claim 22 wherein the multifunctional phenol monomer is a compound having a formula (1), (2) or (3): 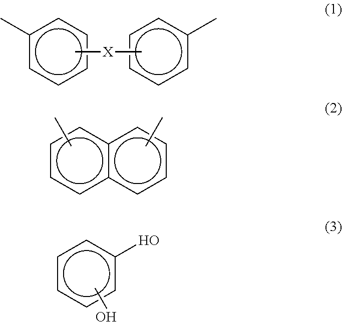
where X is a direct bond, an aliphatic group, an alicyclic group or an aromatic group which may contain a hetero element or functional group.

26. The hybrid benzoxazine resin according to claim 25 wherein the multifunctional phenol monomer is selected from phenolphthalein, biphenol, 4-4′-methylene-di-phenol, 4-4′-dihydroxybenzophenone, bisphenol-A, bisphenol-S, bisphenol-F, 1,8-dihydroxyanthraquinone, 1,6-dihydroxnaphthalene, 2,2′-dihydroxyazobenzene, resorcinol, fluorene bisphenol, 1,3,5-trihydroxy benzene and a mixture thereof.

27. The hybrid benzoxazine resin according to claim 22 wherein the aldehyde compound comprises formaldehyde.

28. The hybrid benzoxazine resin according to claim 22 wherein the organic primary monoamine compound is ammonium, methylamine, ethylamine, propylamine, butylamine, isopropylamine, hexylamine, octadecylamine, cyclohexylamine, 1-aminoanthracene, 4-aminobenzaldehyde, 4-aminobenzophenone, aminobiphenyl, 2-amino-5-bromo pyridine, D-3-amino-ε-caprolactam, 2-amino-2,6-dimethylpiperidine, 3-amino-9-ethylcarbozole, 4-(2-aminoethyl)morpholine, 2-aminofluorene, 1-aminohomopiperidine, 9-aminophenanthrene, 1-aminopyrene, 4-bromoaniline, aniline, toluidene, xylidene, naphthylamine or a mixture thereof.

29. The hybrid benzoxazine resin according to claim 22 wherein a solvent is present and selected from pure benzene, mixed benzene, toluene, xylene, ethylbenzene, octane, methylcyclohexane, butylbenzene, cumene, mesitylene, chlorobenzene, dichlorobenzene, o-chlorotoluene, n-chlorotoluene, p-chlorotoluene, 1,2-dichloroethane, 1,2-dichloropropane, carbon tetrachloride, 1,1,1-trichloroethane, 1,1,2-trichloroethane, 1,1,1,2-tetrachloroethane, 1,1,2,2-tetrachloroethane, trichloroethylene, tetrachloroethylene and a mixture thereof.

30. A method for producing a hybrid benzoxazine resin comprising combining an aldehyde compound, an organic primary monoamine with a multifunctional phenol monomer and a monofunctional phenol monomer and optionally a solvent to form a reactant mixture and heating the reactant mixture for a period of time sufficient to allow the reactants to react and form the hybrid benzoxazine resin and wherein the hybrid benzoxazine resin is substantially monofunctional-free.

31. The method according to claim 30 wherein the monofunctional phenol monomer and multifunctional phenol monomer are combined and added at the same time to the reactant mixture and allowed to react.

32. The method according to claim 30 wherein the monofunctional phenol monomer is added first to the reactant mixture and allowed to react for sufficient period of time prior to the addition of the multifunctional phenol monomer to the reactant mixture.

33. The method according to claim 30 wherein the monofunctional phenol monomer and a portion of the multifunctional phenol monomer are combined and added at the same time to the reactant mixture and allowed to react for a sufficient period of time before the remaining portion of the multifunctional phenol monomer is added to reactant mixture.

34. The method according to claim 30 wherein the reaction temperature ranges from ambient temperature to about 150° C. and the period of time of reaction ranges from about 10 minutes to 10 hours.

35. The method according to claim 34 wherein the period of time of reaction ranges from about 30 minutes to about 4 hours.

36. A thermosetting composition comprising the hybrid benzoxazine resin according to claim 22.

37. The thermosetting resin composition according to claim 36 further comprising one or more of an epoxy resin, a polyphenylene ether resin, a polyimide resin, a silicone resin, a melamine resin, urea resin, cyanate ester resin, a polyphenol or phenol resin, an allyl resin, a polyester resin, a bismaleimide resin, an alkyd resin, a furan resin, a polyurethane resin, an aniline resin, a curing agent, a flame retardant, a filler, a release agent, an adhesion-imparting agent, a surfactant, a colorant, a coupling agent, and/or a leveling agent

38. A cured article comprising the thermosetting composition of claim 36.

39. Use of the thermosetting composition of claim 36 as an adhesive, sealant, coating or encapsulating system for an electronic or electrical component.

40. A cured article comprising bundles or layers of fibers infused with the thermosetting composition of claim 36.

41. A method for producing a prepreg or towpreg comprising the steps of (a) providing a bundle or layer of fibers; (b) providing a thermosetting composition of claim 22; (c) joining the bundle or layer of fibers and phenolic-free composition to form a prepreg or towpreg assembly; (d) optionally removing excess phenolic-free composition from the prepreg or towpreg assembly, and (e) exposing the prepreg or towpreg assembly to elevated temperature and/or pressure conditions sufficient to infuse the bundle or layer of fibers with the phenolic-free composition and form a prepreg or towpreg.

42. A prepreg or towpreg produced according to the method of claim 41.
